(19) United States
(12) Patent Application Publication
(10) Pub. No.: US 2002/0032611 A1
(43) Pub. Date: Mar. 14, 2002

(54) Methods and systems for sourcing bill of material and data handling configurations software

(76) Inventor: Ahmad Hasan Khan, Gaithersburg, MD (US)

Correspondence Address: AHMAD KHAN, 7611 Creekstone Ct., Gaithersburg, MD, 20877, US

(21) Appl. No.: 09/797,668

(22) Filed: Mar. 5, 2001

Related U.S. Application Data
(60) Provisional application No. 60/187,162, filed on Mar. 6, 2000.

(51) Int. Cl. G06F 17/60

(52) U.S. Cl. 705/26

(57) ABSTRACT

A computer implemented method of sourcing a Bill Of Material (BOM) by aggregating multiple vendors' data being part numbers, availability, and other product configuration data from a development or procurement environment. The bill of material may have several items or simply a single item, the system simply take an item number or part number and calls multiple vendor over the internet to get price, availability, quantity in stock, and other related data. Each part in the BOM may have several supply sources, and each part may contain several second sources, and each part may also have several equivalence part numbers. A search is performed by the BOM system to get exhaustively find all suppliers, all second sources, all related part numbers and their associated vendors. The BOM data manager and search software organized this data for the entire BOM in a single session. At the same time user may enter his own part numbers, which are not part of the original searched BOM. The BOM data manager organizes those non BOM part numbers in a separate spreadsheet tab. The bill of material configuration program includes, multiple module being an internet vendor data search engine or any data aggregation module, data management module, internet enabled ecommerce shopping module, and user controls that allow user input of information for use in bill of material configuration computations and data organization for ordering bill of material online, or offline. Methods are disclosed for creating and maintaining the logic for a bill of material data configuration program module, search engine or aggregation module and in the form of data configuration parameters; creating and maintaining the visual controls and user interface; and linking created visual controls with underlying structure represented by the data parameters. Further methods include display of spreadsheet controls, creation and selection windows, and query creation (search engine) and selection windows for creating database queries to access data in external tables. Aggregated vendor searched data can be displayed in expandable and collapsible hierarchies, spreadsheet or windows tabs and can be quickly accessed and organized by clicking in an expanded hierarchical display. The aggregated vendor data can be sorted, searched and formulae evaluated to match a part item in the bill of material to a suitable vendor.

### CROSS-REFERENCE TO RELATED APPLICATIONS

### References Cited [Referenced By]

### U.S. Patent Documents

May., Bennett 395/65

1986 et al.

U.S. Pat. No. 4,591,983

1 U.S. Pat. No. 6,006,195 Product development system and method using integrated process and data management

2 U.S. Pat. No. 5,950,206 Method and apparatus for searching and tracking construction projects in a document information database

3 U.S. Pat. No. 5,893,074 Network based task management

4 U.S. Pat. No. 5,877,966 System and method for creating configurations using templates

5 U.S. Pat. No. 5,793,632 Cost estimating system using parametric estimating and providing a split of labor and material costs

6 U.S. Pat. No. 5,790,847 Integration of groupware with activity based management via facilitated work sessions

7 U.S. Pat. No. 5,765,137 Computer system and computer-implemented process for correlating product requirements to manufacturing cost

8 U.S. Pat. No. 5,761,674 Integrated construction project information management system

9 U.S. Pat. No. 5,761,063 Design and engineering project management system

10 U.S. Pat. NO. 5,754,738 Computerized prototyping system employing virtual system design environment

### Other References

The web advertising brochure “Partminer™ 3.0”, Partminer, Inc. The web site online date of availability of this brochure and of the described item is believed to be Aug. 30, 1998 which is more than one year before the filing date of the present application.

The web advertising brochure “Parts & Vendors”, from Trilogy Design, Inc. The web site online date of availability of this brochure and of the described item is believed to be January, 1996 which is more than one year before the filing date of the present application.

The web advertising brochure “CaptureCIS”, from OrCAD, Inc. The web site online date of availability of this brochure and of the described item is believed to be January, 1996 which is more than one year before the filing date of the present application.

The web advertising brochure “ViewDraw ViewDataBookII”, from Viewlogic, Inc. The web site online date of availability of this brochure and of the described item is believed to be January, 1996 which is more than one year before the filing date of the present application.

STATEMENT REGARDING FEDERALLY SPONSORED RESEARCH OR DEVELOPMENT

Not Applicable

REFERENCE TO A MICROFICHE APPENDIX

Not Applicable

### BACKGROUND OF THE INVENTION

### Description

### TECHNICAL FIELD

The present invention relates generally to component supplier management, materials management, inventory management, internet search engine, data aggregators, and Material Resource Planning (MRP) software systems, and relates more specifically to methods and systems for creating a bill of material, managing bill of material, and using internet search engine with a keyword or bill of material list computer program.

### BACKGROUND OF THE INVENTION

For the past decade, product manufacturers have been reengineering and automating their businesses to bring their product catalogs and inventory information online in order to survive and grow in fiercely competitive global markets. At the same time there are numerous internet enabled online operators which aggregates products from several catalogs, and some products overlap from multiple vendors offering an easy simply normalize view of comparing prices for a single item. Even after all these automations available to users today it is still a time consuming and error prune process of going to each site typing a part number or an item code, gathering all the pricing data from multiple distributors site, and then deciding which is the least expensive vendor for a given part. Now, that has been done for one part number from a bill of material now, the user needs to go through each part number and find he best possible sources and then select a source. Assume if you have ten part numbers and twenty different vendors offering the same items. Then user needs to email, fax or visit the web site for each vendor, and then for each part. A total of 20*10, or 200 times a user would enter a part number. Another alternate is to wait for quote from ten suppliers then mix and match and check pricing for each and divide the master bill of material into several pieces to actually order the given set of parts from a single bill of material.

At the same time the sales channels for these same vendors—including inside and outside salespeople, distributors and resellers—frequently resemble their 1950's counterparts. Sales forces have only recently begun to use computers to assist in the sales process. Even if a sales force has been equipped with a laptop to assist in the sales process, in many cases salespeople still conduct business by using reams of paper catalogs, price lists, and quote sheets. Again, the sales, engineering, and procurement managers need a common bill of material format and a search tool that will match the part numbers or item codes in the bill of material against their internal inventory. Instead these sales people and procurement managers retype the part number into their inventory system and check the part availability, pricing g, and stock number and then create a quote for the customer.

A new type of software, web and client based parts search engine are now available that significantly automates the finding of suppliers for a given part or parts and user has to copy this information into his spreadsheet or purchase ordering system to organize the bill of material with correct part numbers, stock unit name, it's pricing and other data by hand. At best they will cut paste data from a web browser screen or a client screen to get the data organized. All of these tools lack data organization and merging of data with an existing bill of material.

Prior art search engine and bill of material management program have traditionally used a user input or static data architecture. None of the prior art bill of material management system utilizes an internet search engine that finds and scans for the best possible price based on the vendor's inventory level. In such an architecture, the bill of material software must have access to a configuration database, as well as other data relevant to the business, and access this data in response to user input to determine the validity and cost of a configuration. The use of a static suppliers data to build bill of materials can significantly reduce the validity of organized bill of material. Since the pricing, and quantity in stock are dynamic parameters that changes by the second in certain industries. It also limits the use of artificial intelligence technology to predict the correct inventory levels within the company, and predict market demand or shortages of parts of a given electronic, mechanical or chemical system. These bill of material system also do not link in aggregated data, which is generated by a program module which scan vendors catalogs from the Internet or dedicated links.

Today the bill of materials systems or ordering system lack the use of intelligence provided by a data aggregators. The data aggregator finds and aggregates data from multiple vendors on a given product item name or code.

In order to understand the bill of material souring process and the pains associated with the selecting and souring, we will use an industry specific example as noted in FIG. 2. In this FIG. 2. we have build a process flow of an engineer who designs circuit boards, and now want to getting ready in fabricating the electronic printed circuit board (PCB). In this particular case he needs to build a BOM for his PCB board so that correct parts are ordered. This process is driven by getting to the right supplier who stocks the item with the correct part number.

Considerable amount of time is spent researching and finding proper IC components for a given parts list as shown by figure A. This varies from checking for new parts on the market, or exiting parts in a design for price, availability and technical information. Today the design or the procurement process is automated by disparate databases internally to the company and externally on the Internet. A procurement manager or an engineer must spent considerable amount of time searching data at several web sites by hand entering data at the web site, or in a company's internal databases to track and find parts information. This process also involves calling on multiple distributors for parts information and getting pricing and availability. The problem is further complicated when certain parts are either not available on the market and the engineer is informed late in the design cycle to the change design for a substitute part. A part is substituted by looking at part number cross-references via a product called IC Master (5 inch think book), CAPXpert, and also Aspect Development online catalogs. All this hand entry and re-keying of data causes delays in ordering correct parts on time, selecting vendors and synchronizing multiple versions of a single parts list. Complications occur when purchasing is off site and several parts list are involved for sourcing. Searching of IC integrated circuit component data or similar complex parts in other industries yields considerable amount of data for sorting, editing and organizing. Our proposed technique involves the Internet based vendor catalog search results which are then merged with a master BOM, and back annotated into the CAD system. A draft BOM is sent for procurement where procurement managers must spend significant amount of time researching the parts again from company databases and preferred vendors on the Internet. Any changes to BOM must be sent back to the engineer for review and update to his CAD system.

As you can see with the test case above there needs to be a better way to communicate design and procurement data of companies with suppliers. The suppliers are already online, however there is a need for a next-generation bill of material and materials management system that reads live dynamic data from the multiple vendors to make a better more accurate cost effective decision on ordering the parts or filling needed inventory. The reading of live data involves visiting several vendors online then aggregating content to show the availability of parts information for each supplier per part. This information is then displayed in series of spreadsheet tabs and explorer views and merged with the bill of materials. A series of report and new bill of materials are then generated.

A new generation of prior art have recently added search engine in the parts selection process, however it only address one part at time and does not show a complete bill of materials with vendors aggregated parts data. A good example of this is the IQExpert from partminer. User searches for parts to be used in his design system, and can also receive the price and availability of that part from multiple vendors. However it does not have the capability to organize a bill of material with the proper searched data. It also does not handle quantity of parts. The search engine finds all the parts from all vendors, and aggregates all the data in one main screen, which is not a spreadsheet, nor it has any spreadsheet tabs.

Thus, there is a need for improved configuration software that is easier to create and maintain than prior art configurations. There is also a need for a configuration that is flexible and allows easy creation of a custom user interface that can be tailored to the needs of a particular enterprise by allowing inclusion of graphics, operational features such as radio buttons and check boxes, data entry fields, selectable choices on menus, etc., without requiring a developer or user to write program code.

### BRIEF SUMMARY OF THE INVENTION

Briefly described, the present invention provides development tools in the form of a computer program for creating and maintaining the logic and visual interface of a product configuration computer program. The invention lets a user—a configuration developer—create both a visual end user interface (for the salesperson) and the underlying configuration logic. An integrated user interface builder allows the developer to design a configuration screen by dragging and dropping parameters, such as engines available in certain model automobiles, interior features, etc. onto a form. Complex constraints (e.g., what are valid engines for certain model cars and when they are valid) are also defined for parameters to ensure the accuracy and consistency of the salesperson's selections. Formulas specify calculations during parameter entry, such as pricing and default values, and creation of a parts list and descriptive text upon completion of parameter entry. A built-in query tool (based on SQL, ODBC) enables constraints and formulas to access data easily from existing databases.

Another aspect of the present invention is the ability for information that is associated with a control to be derived from an external database or table via, JAVA, or SQL queries. This information is retrieved from a disk file, a network connection, or other source, which can be maintained independently of the MRP/ERP software. In other words, the engineering organization can maintain product information on a parts database, such as price, availability, units in stock, engine model numbers, etc. and link this information via JDBC, ODBC, CORBA and other emerging data connector standards within the CSM (component supplier management program. The user/sales engineer who creates or maintains the product bill of material data merely specifies a path link to the database or file containing the information. Then, when the sales engineer/user is required to update the product BOM information and distribute it to other vendors in the supply chain force, he or she merely saves the file pointer to “web”. This data is saved on the web to a secure location available to only allowed parties via a control list

Accordingly, the present invention provides a convenient and easy way to quickly create a complete bill of material including supplier part numbers pricing, and other relevant engineering and procurement data needed to either order the parts in question or simply keep track of inventory information for further analysis and reduce costly not ordering parts that are readily available in the market.

Another aspect of the present invention relates to representation of all possible vendors and their inventory and pricing levels to better model a stocking scenario internal to a company. This information is also used to keep tack of price movement, trends, volatility, and simply keep track of shortages of parts in the market. Other objects, features, and advantages of the present invention will become apparent upon reading the following specification, when taken in conjunction with the drawings and the appended claims.

### BRIEF DESCRIPTION OF THE SEVERAL VIEWS OF THE DRAWING

FIG. 1 illustrates prior art search engine parts list software.

FIG. 2 is a block diagram illustrating a current design, procurement and bill of material generation flow, using conventional tools like, web, MRP systems, search engine. The figure shows complete disconnect from design data to BOM generation and procurement.

FIG. 3 illustrates the structure of the preferred embodiment of the Bill of Material generation and management environment and software constructed in accordance with the preferred embodiment of the present invention.

FIG. 4 is a screen shot from the example configuration software of FIG. 6, showing the use of organization spreadsheet tabs on the user screen display.

FIG. 5 illustrates the user interface and ordering screen under the BOM environment software constructed in accordance with the preferred embodiment of the present invention. It also shows a new check box type user control to better manage the number of Kits of associated bill of material units to order.

FIG. 6 illustrates the design explorer window showing the design pages selected, for purposes of illustrating the dependency tree concepts.

Other objects, features, and advantages of the present invention will become apparent upon reading the following specification, when taken in conjunction with the drawings and the appended claims.

### BRIEF DESCRIPTION OF THE SEVERAL VIEWS OF THE DRAWING

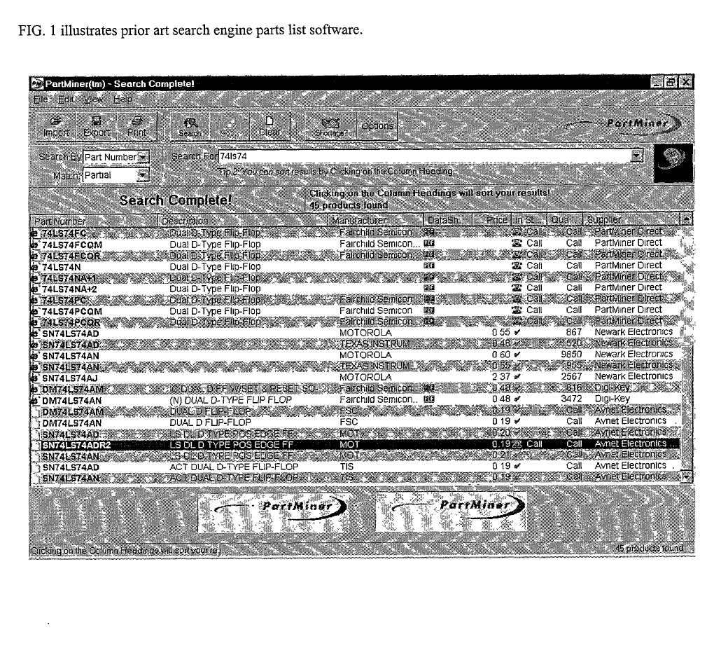

FIG. 1 illustrates prior art search engine parts list software.

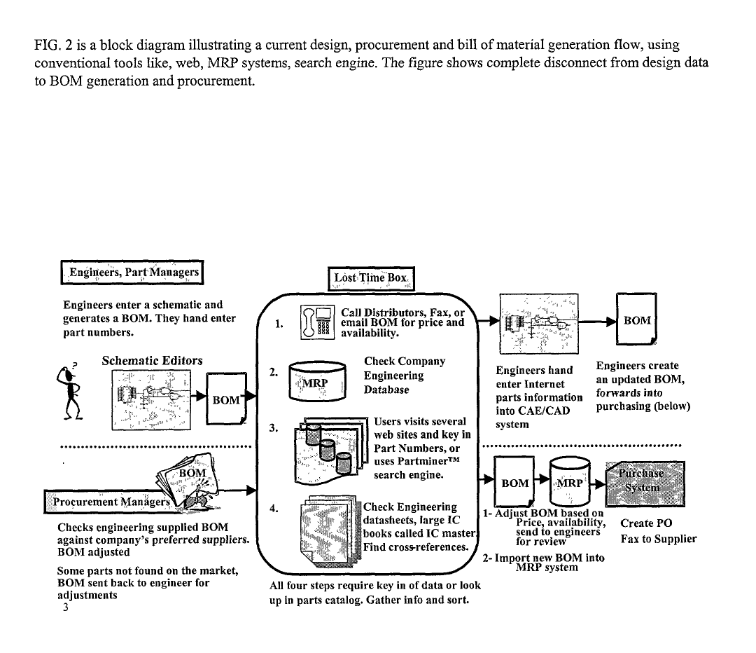

FIG. 2 is a block diagram illustrating a current design, procurement and bill of material generation flow, using conventional tools like, web, MRP systems, search engine. The figure shows complete disconnect from design data to BOM generation and procurement.

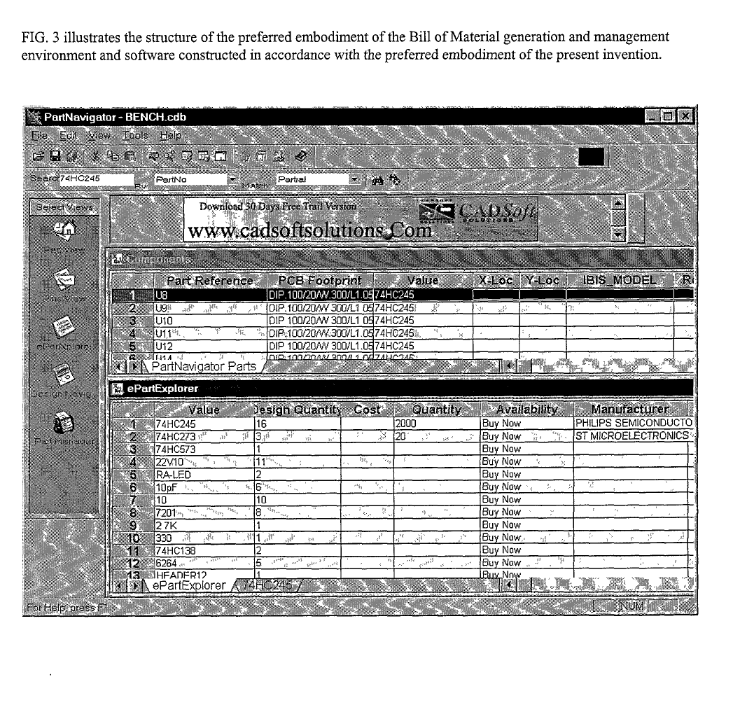

FIG. 3 illustrates the structure of the preferred embodiment of the Bill of Material generation and management environment and software constructed in accordance with the preferred embodiment of the present invention.

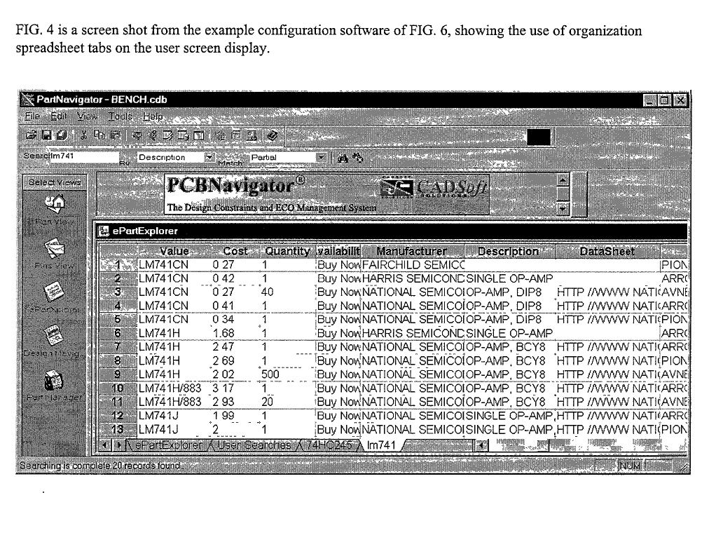

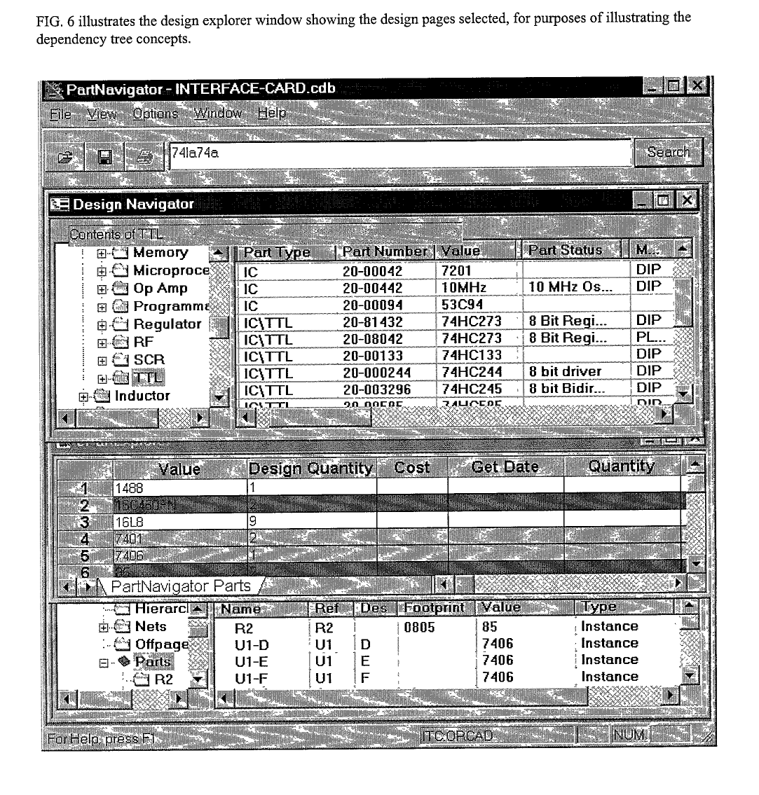

FIG. 4 is a screen shot from the example configuration software of FIG. 6, showing the use of organization spreadsheet tabs on the user screen display.

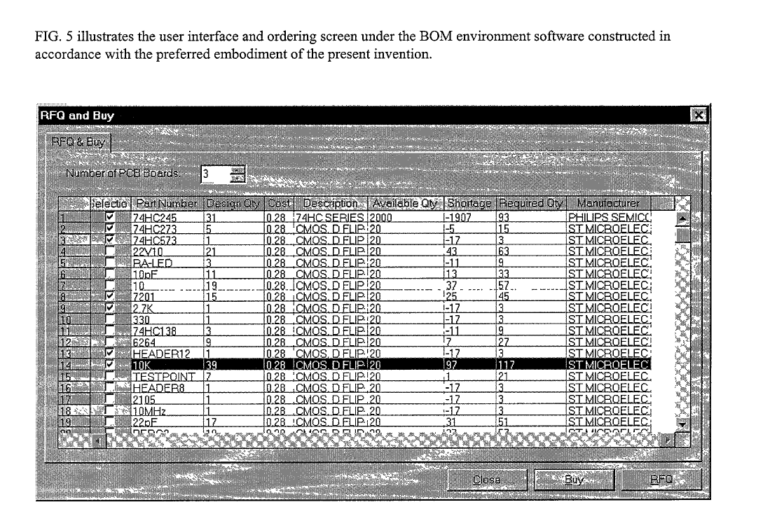

FIG. 5 illustrates the user interface and ordering screen under the BOM environment software constructed in accordance with the preferred embodiment of the present invention. It also shows a new check box type user control to better manage the number of Kits of associated bill of material units to order.

FIG. 6 illustrates the design explorer window showing the design pages selected, for purposes of illustrating the dependency tree concepts.

### DETAILED DESCRIPTION OF THE INVENTION

Briefly described, the present invention provides development tools in the form of a computer program for creating and maintaining the logic and visual interface of a product configuration computer program. The invention lets a user—a configuration developer—create both a visual end user interface (for the salesperson) and the underlying configuration logic. An integrated user interface builder allows the developer to design a configuration screen by dragging and dropping parameters, such as engines available in certain model automobiles, interior features, etc. onto a form. Complex constraints (e.g., what are valid engines for certain model cars and when they are valid) are also defined for parameters to ensure the accuracy and consistency of the salesperson's selections. Formulas specify calculations during parameter entry, such as pricing and default values, and creation of a parts list and descriptive text upon completion of parameter entry. A built-in query tool (based on SQL, ODBC) enables constraints and formulas to access data easily from existing databases. Another aspect of the present invention is the ability for information that is associated with a control to be derived from an external database or table via, JAVA, or SQL queries. This information is retrieved from a disk file, a network connection, or other source, which can be maintained independently of theMRP/ERP software. In other words, the engineering organization can maintain product information on a parts database, such as price, availability, units in stock, engine model numbers, etc. and link this information via JDBC, ODBC, CORBA and other emerging data connector standards within the CSM (component supplier management program. The user/sales engineer who creates or maintains the product bill of material data merely specifies a path link to the database or file containing the information. Then, when the sales engineer/user is required to update the product BOM information and distribute it to other vendors in the supply chain force, he or she merely saves the file pointer to “web”. This data is saved on the web to a secure location available to only allowed parties via a control list Accordingly, the present invention provides a convenient and easy way to quickly create a complete bill of material including supplier part numbers pricing, and other relevant engineering and procurement data needed to either order the parts in question or simply keep track of inventory information for further analysis and reduce costly not ordering parts that are readily available in the market. Another aspect of the present invention relates to representation of all possible vendors and their inventory and pricing levels to better model a stocking scenario internal to a company. This information is also used to keep tack of price movement, trends, volatility, and simply keep track of shortages of parts in the market. Other objects, features, and advantages of the present invention will become apparent upon reading the following specification, when taken in conjunction with the drawings and the appended claims.

### BRIEF DESCRIPTION OF THE SEVERAL VIEWS OF THE DRAWING

FIG. 1 illustrates prior art search engine parts list software.

FIG. 2 is a block diagram illustrating a current design, procurement and bill of material generation flow, using conventional tools like, web, MRP systems, search engine. The figure shows complete disconnect from design data to BOM generation and procurement.

FIG. .3 illustrates the structure of the preferred embodiment of the Bill of Material generation and management environment and software constructed in accordance with the preferred embodiment of the present invention.

FIG. 4 is a screen shot from the example configuration software of FIG. 6, showing the use of organization spreadsheet tabs on the user screen display.

FIG. 5 illustrates the user interface and ordering screen under the BOM environment software constructed in accordance with the preferred embodiment of the present invention. It also shows a new check box type user control to better manage the number of Kits of associated bill of material units to order.

FIG. 6 illustrates the design explorer window showing the design pages selected, for purposes of illustrating the dependency tree concepts.

1. A computer-implemented method of generating a bill of material or parts list configuration program module that executes searches over the internet and intranet to collect all possible vendors data for each item number in the bill of material as shown in FIG. 3. The said program present the aggregated data from multiple vendors in a form of spreadsheet or windows tabs, explorer views, or commonly known as file folders under the Microsoft Windows operating system. The software program module including user controls that allow user input of information such as new part numbers, as part of the original BOM, and presents this data as user spreadsheet or windows tab. The spreadsheet or Windows display may also be combined with explorer views, radio buttons, and dialog boxes, including HTML partial views

2. A Bill of Material system that searches suppliers via Internet or intranet search engine. The search engine aggregates all data for a particular part number and creates a custom tab with Part Numbers to be displayed from multiple vendors.

3. Data aggregation is performed for either a single part, item code or a complete bill of material and market shorts are calculated accordingly. The market shorts are quantities of material that is short in the market as compare what is specified in the bill of material under quantity. Vendors inventory levels are checked against the specified quantities in the bill of material.

4. The computer-implemented method of claim 1, further comprising the step of displaying CAE (Computer Aided Engineering) parts and pins data in spreadsheet and windows explorer form as shown in FIG. 3. Although this does not limit the invention to semiconductor components. A bill of material may be for list of car parts, list of chemicals, or other item codes like a shopping list.

5. The computer-implemented method of claim 1, wherein also shows indicators for failed searches. Searches of part item data which no vendor data exists like part numbers, price etc.

6. The computer-implemented method of claim 1, wherein the parameter selector window includes a control that expands the display of parameters into a hierarchical arrangement of object parameters.

7. The computer-implemented method of claim 5, wherein the pins view selector window includes a pins icon that when activated by a user command, expands to display one or more spreadsheet views in tab form of pins data of a component part.

8. The computer-implemented method of claim 1, wherein the control object in the controls palette or commonly known as tools palate is activated by the user pointing to a predetermined region on the controls palette and activating a command entry device.

9. The computer-implemented method of claim 9, wherein the user modification of the selected number of PCB board dialog box comprises use of a multiplier formula.

10. The computer-implemented method of claim 1, can also be compiled and ran under a web browser. The search engine, and associated displays in spreadsheet or table forms can also be displayed and managed in the web browser.
